(19) United States
(12) Patent Application Publication
(10) Pub. No.: US 2025/0133319 A1
(43) Pub. Date: Apr. 24, 2025

(54) ACOUSTIC TRANSDUCER

(71) Applicants: Ayumu MURAKAMI, Tokyo (JP); Yuki UCHIDA, Tokyo (JP); Yoshitaka TATARA, Tokyo (JP); Naoki YOSHIDA, Tokyo (JP)

(72) Inventors: Ayumu MURAKAMI, Tokyo (JP); Yuki UCHIDA, Tokyo (JP); Yoshitaka TATARA, Tokyo (JP); Naoki YOSHIDA, Tokyo (JP)

(73) Assignee: MMI SEMICONDUCTOR CO., LTD., Tokyo (JP)

(21) Appl. No.: 18/919,852

(22) Filed: Oct. 18, 2024

(30) Foreign Application Priority Data
Oct. 24, 2023 (JP) 2023-182686

(51) Int. Cl. H04R 1/08; H04R 7/04; H04R 7/18; H04R 19/04

(52) U.S. Cl. CPC H04R 1/086; H04R 7/04; H04R 7/18; H04R 19/04; H04R 2201/003; H04R 2307/023

(57) ABSTRACT

An acoustic transducer includes a substrate having an opening, a diaphragm disposed to cover the opening, and a fixed electrode facing the diaphragm. An opening for frequency characteristics adjustment is formed in a region outward of an outer periphery of the fixed electrode.

### CROSS-REFERENCE TO RELATED APPLICATIONS

This application is based on and claims priority to Japanese Patent Application No. 2023-182686, filed on Oct. 24, 2023, the entire contents of which are incorporated herein by reference.

### TECHNICAL FIELD

The present disclosure relates to an acoustic transducer.

### BACKGROUND

For example, a microphone including a substrate having an opening, a vibrating electrode plate formed to cover the opening, a back plate formed to cover the vibrating electrode plate, and a fixed electrode plate provided at the back plate, is known (see, for example, Japanese Patent No. 6127595). The microphone disclosed in Japanese Patent No. 6127595 is provided with a plurality of holes at a center area of the vibrating electrode plate.

### SUMMARY

An acoustic transducer according to one aspect of the present disclosure includes a substrate having an opening, a diaphragm disposed to cover the opening, and a fixed electrode facing the diaphragm. An opening for frequency characteristics adjustment is formed in a region outward of an outer periphery of the fixed electrode.

### BRIEF DESCRIPTION OF THE DRAWINGS

FIG. 1 is an exploded perspective view illustrating a micro electro mechanical system (MEMS) microphone according to a first embodiment;

FIG. 2 is a plan view illustrating a diaphragm;

FIG. 3 is a cross-sectional view illustrating a surface cut taken along the line III-III in FIG. 2;

FIG. 4 is a plan view illustrating a portion of a diaphragm of a MEMS microphone according to a second embodiment;

FIG. 5 is a plan view illustrating a portion of a diaphragm of a MEMS microphone according to a third embodiment;

FIG. 6 is a plan view illustrating a diaphragm of a MEMS microphone according to a fourth embodiment;

FIG. 7 is a cross-sectional view illustrating a surface cut taken along the line VII-VII in FIG. 6;

FIG. 8 is a cross-sectional view illustrating a surface cut taken along the line VIII-VIII in FIG. 6;

FIG. 9 is a partial plan view illustrating a diaphragm of a MEMS microphone according to a fifth embodiment; and

FIG. 10 is a cross-sectional view illustrating a surface cut taken along the line X-X in FIG. 9.

### DETAILED DESCRIPTION

For existing microphones, foreign matter entering through an opening in a substrate may pass through a plurality of holes provided at a center area of a vibrating electrode plate (diaphragm), and enter the space between the vibrating electrode plate and a fixed electrode plate.

The present disclosure provides an acoustic transducer that can suppress entry of foreign matter into the space between a diaphragm and a fixed electrode.

In the following, an acoustic transducer according to an embodiment of the present disclosure will be described with reference to the accompanying drawings. In the present specification and drawings, substantially the same components are denoted by the same reference symbols, and redundant description may be omitted.

### MEMS Microphone 100 According to First Embodiment

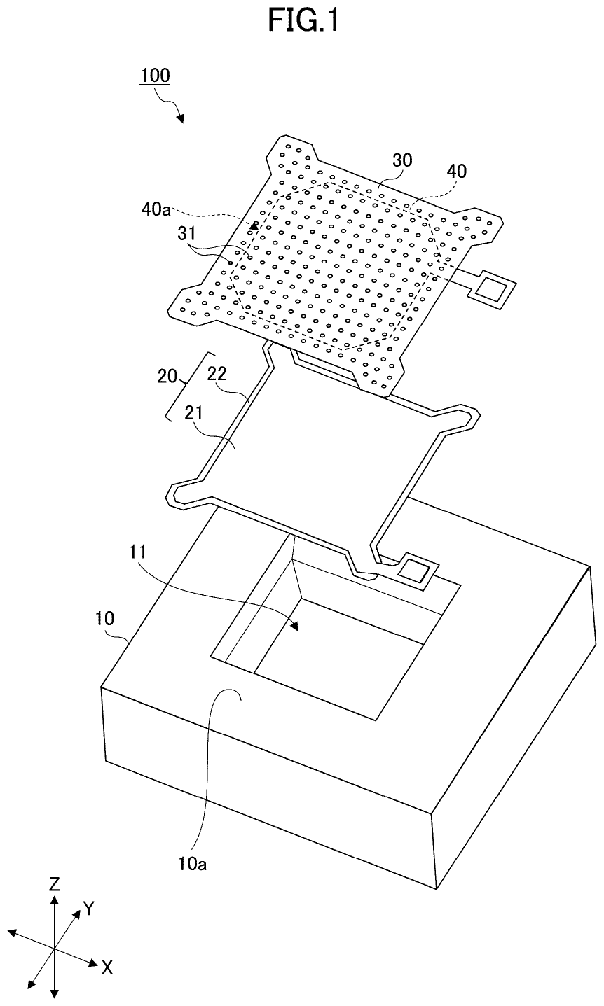

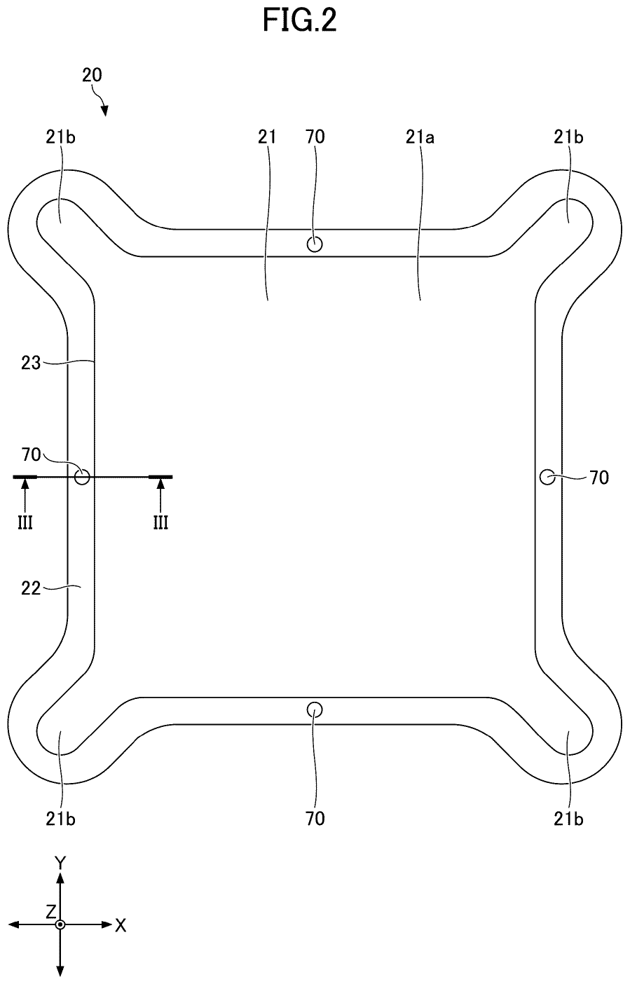

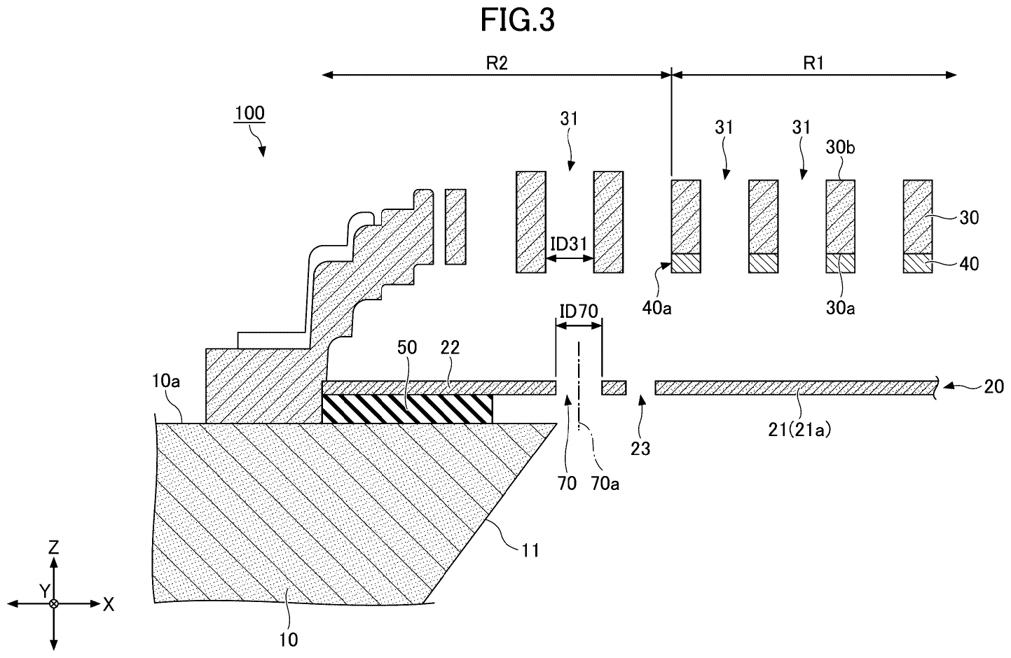

A MEMS microphone 100 according to a first embodiment will be described with reference to FIGS. 1 to 3. FIG. 1 is an exploded perspective view illustrating the MEMS microphone 100 according to the first embodiment. FIG. 2 is a plan view illustrating a diaphragm 20. FIG. 3 is a cross-sectional view illustrating a surface cut taken along the line III-III in FIG. 2. In each of the drawings, three orthogonal directions, i.e., an X-axis direction, a Y-axis direction, and a Z-axis direction, are illustrated. The Z-axis direction is a plate thickness direction of a substrate 10, and is an example of a first direction. In the following description, “upper” and “lower” may be used, but the arrangement of the MEMS microphone 100 is not limited to these terms.

As illustrated in FIG. 1, the MEMS microphone 100 includes the substrate 10, the diaphragm 20, a back plate 30, a fixed electrode 40, and a support 50. The MEMS microphone 100 is an example of an “acoustic transducer”. The MEMS microphone 100 is a capacitive element that is produced using MEMS technology. “MEMS” is an abbreviation of Micro Electro Mechanical System. The acoustic transducer is not limited to the MEMS microphone 100, but may be any other acoustic sensor or a speaker.

### Substrate 10

The substrate 10 is formed of single crystal silicon or the like. The substrate 10 may be formed in a rectangular parallelepiped shape, for example, through dicing. The substrate 10 has an opening 11 that penetrates through the substrate 10 in the Z-axis direction. The opening 11 is also referred to as a cavity. The opening 11 has, for example, a rectangular shape as viewed in the Z-axis direction. The shape of the opening 11 is not limited to a rectangular shape, but may be any other shape. The substrate 10 includes a first surface 10a and a second surface that face each other in the Z-axis direction. The first surface 10a is a surface that is closer to the diaphragm 20 in the Z-axis direction.

### Diaphragm 20

The diaphragm 20 has conductivity, and is disposed to cover the opening 11. The diaphragm 20 is a polysilicon thin film having conductivity. The diaphragm 20 is a vibrating electrode plate. The thickness direction of the diaphragm 20 is along the Z-axis direction. The diaphragm 20 includes a movable film 21 and a fixed film 22. The movable film 21 is disposed to cover the opening 11 in the Z-axis direction. As illustrated in FIG. 2, the movable film 21 includes a body 21a having a substantially rectangular shape, and projections 21b projecting outward from the corners of the body 21a.

The body 21a is disposed to overlap with the opening 11 as viewed in the Z-axis direction. The projections 21b are disposed to overlap with the first surface 10a of the substrate 10 as viewed in the Z-axis direction. The projections 21b are fixed to the first surface 10a of the substrate 10. The projections 21b may be fixed to the substrate 10 via the support 50 disposed between the projections 21b and the first surface 10a of the substrate 10 in the Z-axis direction. The body 21a is a portion that is vibratable in the Z-axis direction.

### Fixed Film 22

The fixed film 22 is disposed around the movable film 21 as viewed in the Z-axis direction. The fixed film 22 is formed to enclose the movable film 21. The fixed film 22 is disposed to overlap with the first surface 10a of the substrate 10 as viewed in the Z-axis direction. The fixed film 22 is fixed to the first surface 10a of the substrate 10 via the support 50.

### Slit 23

A slit 23 is formed between the movable film 21 and the fixed film 22 in the X-axis direction and the Y-axis direction. The slit 23 is a portion in which the diaphragm 20 is absent. The slit 23 is formed to enclose the movable film 21. The width of the slit 23 crossing the longitudinal direction of the slit 23 may be, for example, 0.38 micrometers (μm). The slit 23 is formed to penetrate through the diaphragm 20 in the Z-axis direction. The slit 23 can be formed by etching a single film of polysilicon, thereby achieving separation into the movable film 21 and the fixed film 22.

### Back Plate 30

The back plate 30 is disposed such that the diaphragm 20 is between the substrate 10 and the back plate 30 in the Z-axis direction. The plate thickness direction of the back plate 30 is along the Z-axis direction. The back plate 30 is disposed apart from the diaphragm 20 in the Z-axis direction. A predetermined space is formed between the diaphragm 20 and the back plate 30. The back plate 30 is disposed to cover the opening of the substrate 10 as viewed in the Z-axis direction.

The back plate 30 is provided with a plurality of holes 31 that penetrate through the back plate 30 in the Z-axis direction. The plurality of holes 31 are arranged at predetermined intervals in the X-axis direction and the Y-axis direction. The plurality of holes 31 are acoustic holes through which acoustic vibrations pass. The back plate 30 includes a first surface 30a and a second surface 30b that face each other in the Z-axis direction. In the Z-axis direction, the first surface 30a is a surface that is closer to the diaphragm 20, whereas the second surface 30b is a surface that is farther from the diaphragm 20.

The peripheral edge of the back plate 30 is disposed at a position overlapping with the first surface 10a of the substrate 10 as viewed in the Z-axis direction. The peripheral edge of the back plate 30 is disposed outward of the diaphragm 20 in the X-axis direction and the Y-axis direction, and is fixed to the first surface 10a of the substrate 10.

### Fixed Electrode 40

The fixed electrode 40 is formed at the first surface 30a of the back plate 30. The fixed electrode 40 is disposed to face the body 21a of the movable film 21 of the diaphragm 20 in the Z-axis direction. The fixed electrode 40 is disposed inward of the slit 23 in the X-axis direction and the Y-axis direction. The fixed electrode 40 is disposed at a position overlapping with the opening 11 of the substrate 10 as viewed in the Z-axis direction.

### Capacitance C

The diaphragm 20 and the fixed electrode 40 are disposed apart from each other in the Z-axis direction, and function as parallel plates. The body 21a of the movable film 21 of the diaphragm 20 is a movable electrode, and is displaced in the Z-axis direction by the action of a sound pressure. This causes a change in capacitance C between the diaphragm 20 and the fixed electrode 40. The MEMS microphone 100 can perform sensing of a sound by converting the change in the capacitance C into a voltage.

### Frequency Characteristics

One of the main characteristics of a microphone is responsiveness of a sensor to the frequency of a sound. This is referred to as “frequency characteristics”. To reduce wind noise and environmental sounds in the microphone, for example, the sensitivity in the range of about 10 Hz or more and about 100 Hz or less may be intentionally reduced. By forming an opening in a portion of the diaphragm 20, desired frequency characteristics are achieved.

### Opening 70 for Frequency Characteristics Adjustment

As illustrated in FIGS. 2 and 3, the fixed film 22 is provided with an opening 70 for frequency characteristics adjustment. Hereinafter, the “opening 70 for frequency characteristics adjustment” may be abbreviated as “opening 70”. The opening 70 penetrates through the fixed film 22 in the Z-axis direction. The shape of the opening 70 is, for example, a circular shape. The shape of the opening 70 is not limited to a circular shape, but may be an elliptical shape, a rectangular shape, a triangular shape, or any other shape. The inner diameter of the opening 70 may be, for example, 1 μm or more and 30 μm or less.

A plurality of openings 70 may be formed in the fixed film 22. In the MEMS microphone 100, for example, a total of four openings 70 may be formed. The plurality of openings 70 may be formed at two positions on both sides in the X-axis direction with respect to the movable film 21 and at two positions on both sides in the Y-axis direction with respect to the movable film 21. The positions and number of the openings 70 are not limited thereto.

As viewed in the Z-axis direction, the openings 70 are formed at positions overlapping with the holes 31 of the back plate 30. For example, a center 70a of the opening 70 is disposed at a position overlapping with the hole 31. The hole 31 is formed upward of the opening 70 in the Z-axis direction.

The opening 70 is formed in a region R2 that is outward of an outer periphery 40a of the fixed electrode 40. The region R2 is formed outward of a region R1. The region R1 is a region in which the diaphragm 20 and the fixed electrode 40 face each other. The region R1 is formed inward of the outer periphery 40a of the fixed electrode 40. The outer periphery 40a of the fixed electrode 40 may be the outermost edge of the fixed electrode 40. The opening 70 is disposed at a position overlapping with the region R2 as viewed in the Z-axis direction.

### Effects of MEMS Microphone 100 According to First Embodiment

The MEMS microphone 100 according to the first embodiment includes the substrate 10 having the opening 11, the diaphragm 20 disposed to cover the opening 11, and the fixed electrode 40 facing the diaphragm 20. The opening 70 for frequency characteristics adjustment is formed in the region R2 that is outward of the outer periphery of the fixed electrode 40.

According to the MEMS microphone 100 as described above, the frequency characteristics can be improved by formation of the opening 70, and the sensitivity to a sound having a frequency of a band inaudible to a human can be reduced. The MEMS microphone 100 can intentionally reduce the sensitivity to wind noise and environmental sounds.

Also, the opening 70 is formed in the region R2 of the MEMS microphone 100. Thus, the MEMS microphone 100 can suppress entry of foreign matter into the space between the diaphragm 20 and the fixed electrode 40. Because the entry of foreign matter into the space between the diaphragm 20 and the fixed electrode 40 is suppressed in the MEMS microphone 100, a possibility of occurrence of a short circuit between the two electrodes, i.e., the diaphragm 20 and the fixed electrode 40, is reduced. This can enhance reliability of the MEMS microphone 100. When the foreign matter is a conductor, a short circuit may occur. However, according to the MEMS microphone 100, the possibility of entry of foreign matter is low, and thus a short circuit is less likely to occur.

Also, the fixed electrode 40 of the MEMS microphone 100 is not formed at a position facing the opening 70. Thus, even if the entry of foreign matter through the opening 70 occurs, a possibility that such foreign matter contacts the fixed electrode 40 is reduced.

When foreign matter is caught between the diaphragm 20 and the fixed electrode 40, displacement of the diaphragm 20 is suppressed. However, according to the MEMS microphone 100, the entry of the foreign matter into the space between the diaphragm 20 and the fixed electrode 40 is suppressed, and thus the displacement of the diaphragm 20 is not appreciably suppressed. This suppresses a reduction in the sensitivity of the MEMS microphone 100.

Also, according to the MEMS microphone 100, the opening 70 for frequency characteristics adjustment is provided in the diaphragm 20. The MEMS microphone 100 as described above is readily produced because the opening 70 is provided only in the diaphragm 20. In addition, the frequency characteristics can be adjusted in a simple configuration.

The MEMS microphone 100 is provided with the plurality of openings 70 for frequency characteristics adjustment. According to this MEMS microphone 100, the inner diameter of one of the openings 70 can be made small. Thus, the frequency characteristics can be adjusted while suppressing a reduction in the strength of the diaphragm 20.

Also, the diaphragm 20 of the MEMS microphone 100 includes the movable film 21 capable of vibrating in the Z-axis direction, and the fixed film 22 disposed around the movable film 21 and fixed to the substrate 10. The openings 70 for frequency characteristics adjustment are provided in the fixed film 22.

According to the MEMS microphone 100 as described above, the fixed film 22 is formed around the movable film 21, and the slit 23 is formed between the movable film 21 and the fixed film 22. The MEMS microphone 100 having this configuration can ensure acoustic resistance, and provide a sound pressure difference between both surfaces of the diaphragm 20. Both surfaces of the diaphragm 20 are surfaces that face each other in the thickness direction of the diaphragm 20, i.e., a surface closer to the opening 11 of the substrate 10 and a surface closer to the fixed electrode 40.

Also, the opening 70 is formed in the fixed film 22, and thus there is no need to form an opening in the movable film 21. Therefore, the frequency characteristics can be adjusted while suppressing a reduction in the strength of the movable film 21. Further, when an opening is formed in the movable film 21, there is a possibility of deformation of the movable film 21, such as warpage and the like. However, according to the MEMS microphone 100, the opening 70 is formed in the fixed film 22, and thus the possibility of deformation of the movable film 21, such as warpage and the like, is reduced.

Also, the MEMS microphone 100 includes the back plate 30 that is fixed to the substrate 10. The fixed electrode 40 is formed at the first surface 30a of the back plate 30 facing the diaphragm 20. The back plate 30 is provided with the plurality of holes 31 penetrating through the back plate 30 in the Z-axis direction. The area of the openings 70 for frequency characteristics adjustment is smaller than the area of the plurality of holes 31. An inner diameter ID31 of one of the holes 31 is larger than an inner diameter ID70 of one of the openings 70.

According to the MEMS microphone 100 having this configuration, the inner diameter ID31 of the hole 31 formed in the back plate 30 is larger than the inner diameter ID70 of the opening 70 for frequency characteristics adjustment. Thus, foreign matter entering through the opening 70 is readily discharged to the exterior through the hole 31. This reduces a possibility that foreign matter exists between the back plate 30 and the diaphragm 20.

Also, according to the MEMS microphone 100, the hole 31 is formed at a position overlapping with the opening 70 as viewed in the Z-axis direction. Thus, the foreign matter passing through the opening 70 advances without changing the advancing direction, and is readily discharged to the exterior of the back plate 30 through the hole 31. Therefore, foreign matter does not appreciably stay in the space between the diaphragm 20 and the back plate 30.

### MEMS Microphone 100 According to Second Embodiment

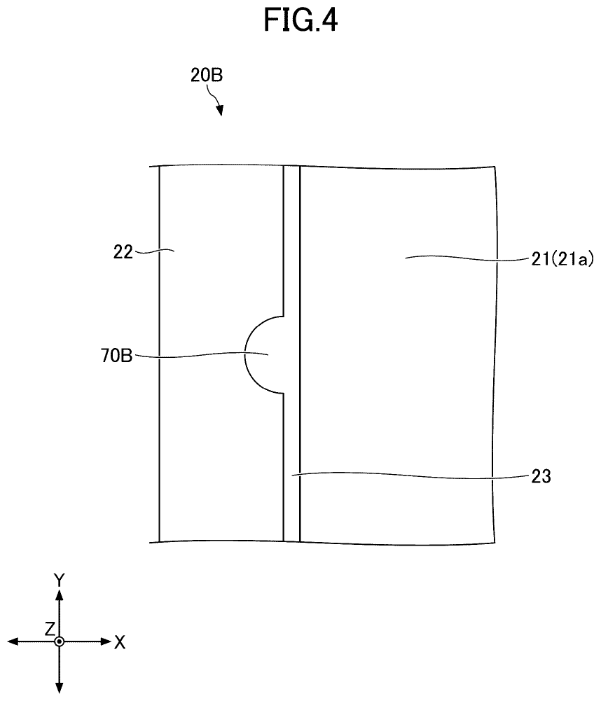

Next, a MEMS microphone 100 according to the second embodiment will be described. FIG. 4 is a plan view illustrating a portion of a diaphragm 20B of the MEMS microphone according to the second embodiment. The MEMS microphone 100 according to the second embodiment is different from the MEMS microphone 100 according to the first embodiment in terms of the arrangement and shape of openings 70B for frequency characteristics adjustment. For the description of the second embodiment, the same description as in the first embodiment may be omitted.

The MEMS microphone 100 according to the second embodiment includes the diaphragm 20B. The diaphragm 20B includes the movable film 21 and the fixed film 22. The openings 70B for frequency characteristics adjustment are formed in the fixed film 22. The opening 70B is formed in a semicircular shape. The shape of the opening 70B is not limited to a semicircular shape, but may be a rectangular shape, a semielliptical shape, a substantially circular shape, or any other shape.

The opening 70B is in communication with the slit 23. The opening 70B is formed to project from the slit 23 in a direction away from the movable film 21. The slit 23 may include the opening 70B. The width of the slit 23 may be different from portion to portion in the longitudinal direction of the slit 23. The width of the slit 23 is, for example, along the X-axis direction. The longitudinal direction of the slit 23 is, for example, along the Y-axis direction.

### Effects of MEMS Microphone 100 According to Second Embodiment

The MEMS microphone 100 according to the second embodiment as described above produces substantially the same effects as those produced by the MEMS microphone 100 according to the first embodiment as described above. The opening 70B for frequency characteristics adjustment may be formed to be in communication with the slit 23. According to the MEMS microphone 100 having this configuration, the minimum width of the fixed film 22 can be increased. This can suppress a reduction in the strength of the fixed film 22. According to the MEMS microphone 100 according to the second embodiment, the minimum width of the fixed film 22 can be increased compared to a configuration in which the opening 70 is formed at the center in the width direction of the fixed film 22.

### MEMS Microphone 100 According to Third Embodiment

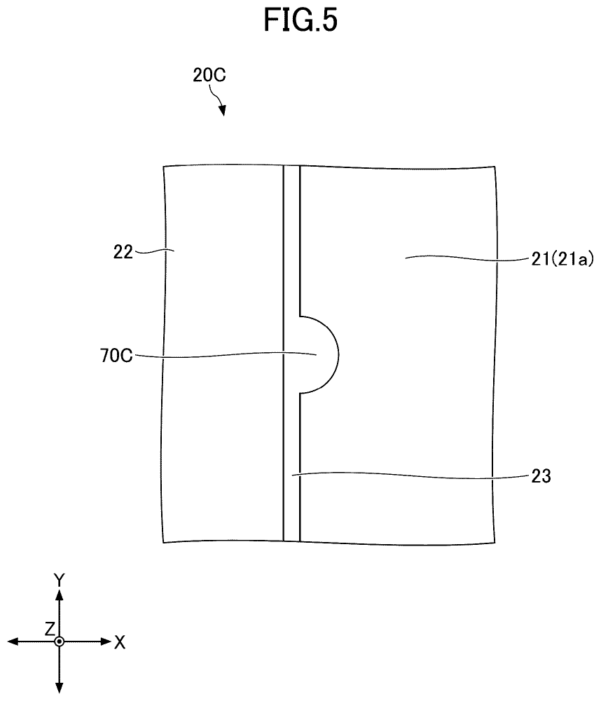

Next, the MEMS microphone 100 according to the third embodiment will be described. FIG. 5 is a plan view illustrating a portion of a diaphragm 20C of the MEMS microphone according to the third embodiment. The MEMS microphone 100 according to the third embodiment is different from the MEMS microphone 100 according to the second embodiment in terms of the arrangement and shape of openings 70C for frequency characteristics adjustment. For the description of the third embodiment, the same description as in the first and second embodiments may be omitted.

The MEMS microphone 100 according to the third embodiment includes the diaphragm 20C. The diaphragm 20C includes the movable film 21 and the fixed film 22. The movable film 21 is provided with the openings 70C for frequency characteristics adjustment. The opening 70C is formed in a semicircular shape.

The opening 70C is in communication with the slit 23. The opening 70C is formed to project from the slit 23 in a direction away from the fixed film 22. The slit 23 may include the opening 70C. The periphery of the movable film 21 is formed to be recessed inward. The opening 70C may be formed in this manner.

### Effects of MEMS Microphone 100 According to Third Embodiment

The MEMS microphone 100 according to the third embodiment as described above produces substantially the same effects as those produced by the MEMS microphone 100 according to the first embodiment as described above. The opening 70C for frequency characteristics adjustment may be formed to be in communication with the slit 23.

Also, according to the MEMS microphone 100, the opening 70C for frequency characteristics adjustment is provided in the movable film 21. According to the MEMS microphone 100 having this configuration, there is no need to form the opening 70C in the fixed film 22. This can suppress a reduction in the strength of the fixed film 22. In addition, by disposing the opening 70C for frequency characteristics adjustment further inward in the opening 11, even if the dimensions of the opening 11 are varied, it is possible to maintain the relationship that the opening 70C for frequency characteristics adjustment faces the opening 11, and variation in the frequency characteristics can be suppressed.

The opening 70C for frequency characteristics adjustment formed in the movable film 21 need not be continuous with the slit 23. The opening 70C may be formed in the region R2 that is outward of the diaphragm 20 and the outer periphery 40a of the fixed electrode 40. Also, according to the MEMS microphone 100, the opening 70B may be formed in the fixed film 22 and the opening 70C may be formed in the movable film 21.

### MEMS Microphone 100D According to Fourth Embodiment

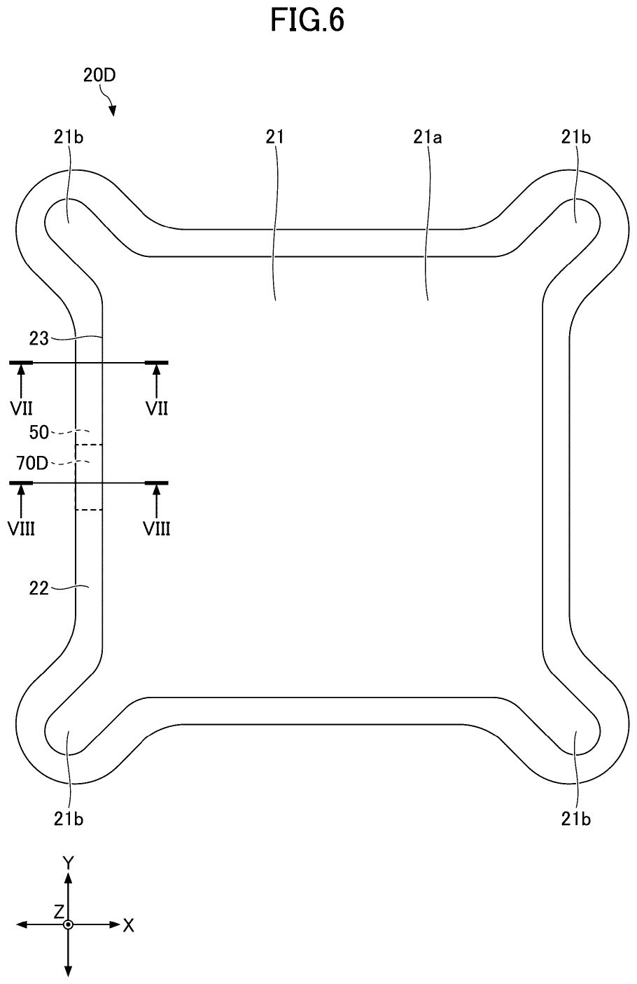

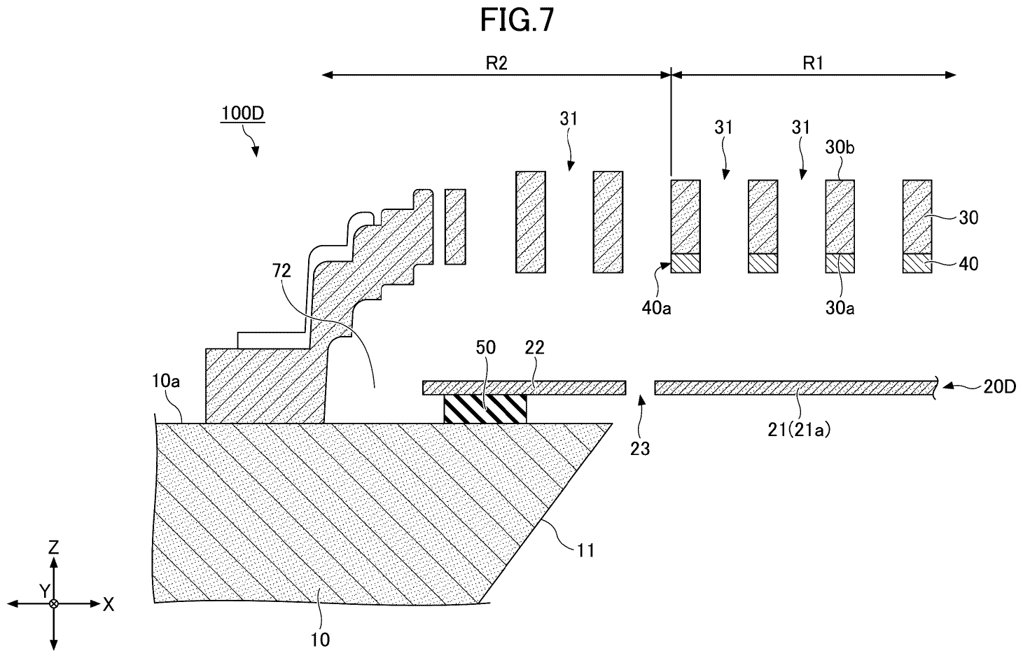

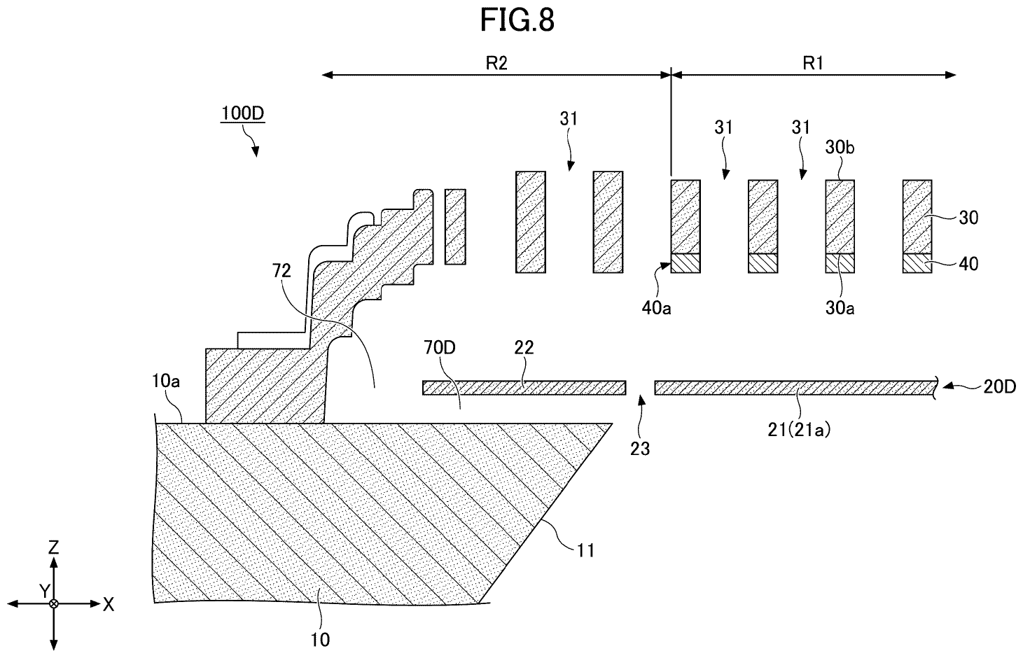

Next, a MEMS microphone 100D according to the fourth embodiment will be described. FIG. 6 is a plan view illustrating a diaphragm 20D of the MEMS microphone 100D according to the fourth embodiment. FIG. 7 is a cross-sectional view illustrating the surface cut taken along the line VII-VII in FIG. 6. FIG. 8 is a cross-sectional view illustrating the surface cut taken along the line VIII-VIII in FIG. 6. The MEMS microphone 100D according to the fourth embodiment is different from the MEMS microphone 100 according to the first embodiment in terms of the arrangement and shape of an opening 70D for frequency characteristics adjustment. For the description of the fourth embodiment, the same description as in the first to third embodiments may be omitted.

As illustrated in FIGS. 6 to 8, the MEMS microphone 100D includes the diaphragm 20D. The diaphragm 20D includes the movable film 21 and the fixed film 22. The opening 70D for frequency characteristics adjustment is not formed in the diaphragm 20D.

According to the MEMS microphone 100D, the opening 70D for frequency characteristics adjustment is formed in the region R2 that is outward of the outer periphery 40a of the fixed electrode 40 as viewed in the Z-axis direction. The opening 70D is formed to penetrate through the support 50 in the X-axis direction. As illustrated in FIG. 8, the opening 70D is formed between the diaphragm 20D and the first surface 10a of the substrate 10 in the Z-axis direction. The opening 70D is formed at a position facing the first surface 10a of the substrate 10 in the Z-axis direction. In other words, the opening 70D is not in contact with the opening 11 in the Z-axis direction.

The opening 70D may be formed between a plurality of supports 50. The support 50 may have a plurality of openings 70D. Also, for example, a recess may be formed at the upper or lower surface of the support 50, thereby forming the opening 70D that penetrates through the support 50 in the width direction.

As illustrated in FIGS. 7 and 8, a gap 72 is formed between the diaphragm 20D and the back plate 30 in the X-axis direction. The gap 72 is in communication with the opening 70D.

### Effects of MEMS Microphone 100D According to Fourth Embodiment

The MEMS microphone 100D according to the fourth embodiment as described above produces substantially the same effects as those produced by the MEMS microphone 100 according to the first embodiment as described above. The opening 70D for frequency characteristics adjustment may be formed in the support 50.

The MEMS microphone 100D includes the support 50 that is disposed between the substrate 10 and the diaphragm 20D in the Z-axis direction (first direction), is disposed so as to enclose the opening 11 of the substrate 10 as viewed in the Z-axis direction, and supports the diaphragm 20D. The opening 70D for frequency characteristics adjustment penetrates through the support 50 in the X-axis direction (second direction crossing the first direction).

According to the MEMS microphone 100D having this configuration, the opening 70D penetrating through the support 50 in the X-axis direction is formed. This reduces a possibility that foreign matter entering through the opening 11 enters the opening 70D. Therefore, a possibility that foreign matter passes through the opening 70D and further through the gap 72 and enters the space between the diaphragm 20 and the fixed electrode 40, is reduced.

According to the MEMS microphone 100D, the opening 70D for frequency characteristics adjustment is provided at a position facing the substrate 10 in the Z-axis direction. Thus, for example, it is less likely that foreign matter passing through the opening 11 in the Z-axis direction strikes the diaphragm 20D, and enters the space between the diaphragm 20D and the fixed electrode 40. The MEMS microphone 100D can suppress the entry of foreign matter into the space between the diaphragm 20D and the fixed electrode 40.

### MEMS Microphone 100E According to Fifth Embodiment

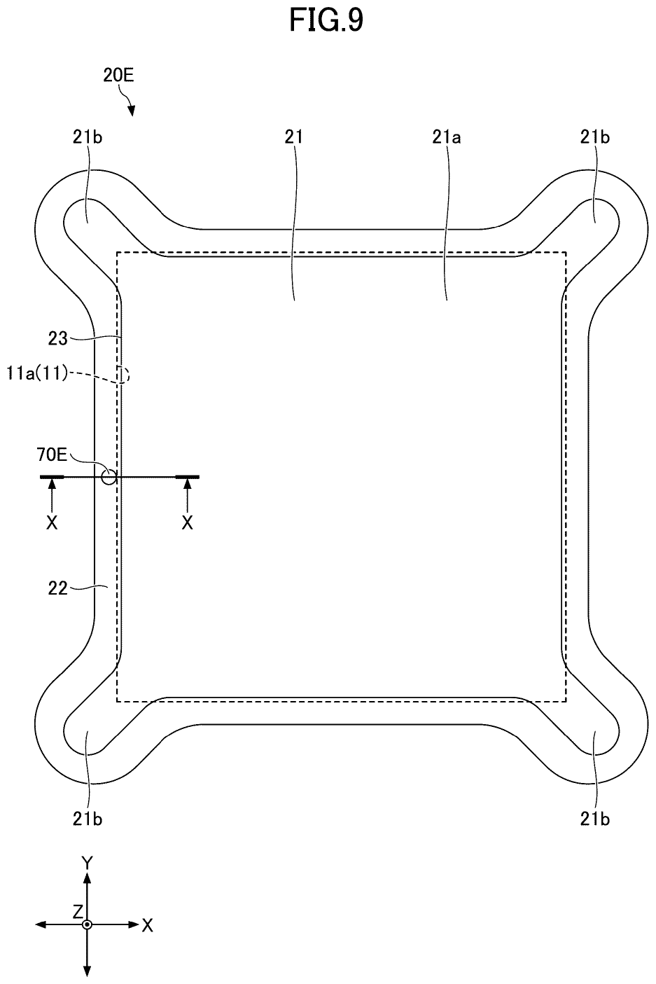

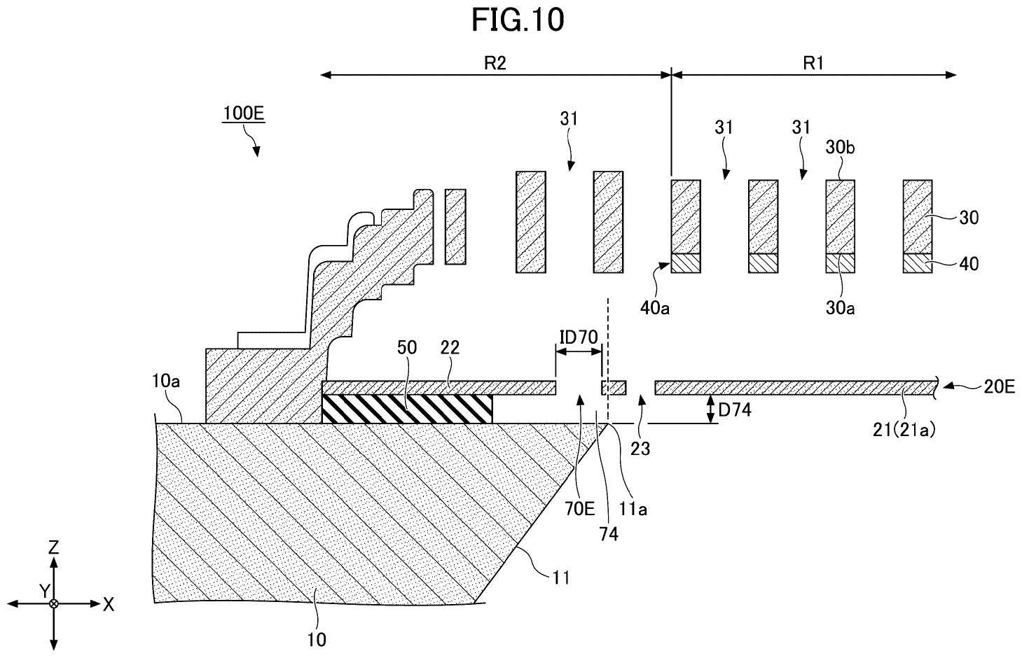

Next, a MEMS microphone 100E according to the fifth embodiment will be described. FIG. 9 is a plan view illustrating a diaphragm 20E of the MEMS microphone 100E according to the fifth embodiment. FIG. 10 is a cross-sectional view illustrating the surface cut taken along the line X-X in FIG. 9. The MEMS microphone 100E according to the fifth embodiment is different from the MEMS microphone 100 according to the first embodiment in terms of the arrangement of an opening 70E for frequency characteristics adjustment. For the description of the fifth embodiment, the same description as in the first to fourth embodiments may be omitted.

The MEMS microphone 100E includes the diaphragm 20E. The diaphragm 20E includes the movable film 21 and the fixed film 22. The opening 70E for frequency characteristics adjustment is formed in the fixed film 22. The opening 70E is formed to face the first surface 10a of the substrate 10 in the Z-axis direction. The opening 70E is not in contact with the opening 11 in the Z-axis direction. The opening 70E is disposed outward of a peripheral edge 11a of the opening 11 in the X-axis direction. The peripheral edge 11a may be an end of the first surface 10a of the substrate 10 on the opening 11 side. In FIG. 9, the peripheral edge 11a of the opening 11 of the substrate 10 is shown with a dashed line.

As illustrated in FIG. 10, a gap 74 is formed between the diaphragm 20E and the first surface 10a of the substrate 10 in the Z-axis direction. The gap 74 is formed between the support 50 and the peripheral edge 11a of the opening 11 in the Z-axis direction. The opening 70E for frequency characteristics adjustment is in communication with the gap 74 and the opening 11.

A gap width D74 of the gap 74 may be, for example, 2 μm or less. The gap width D74 may be a gap width along the Z-axis direction of the gap 74, and may be a length between the first surface 10a of the substrate 10 and the diaphragm 20E. The acoustic resistance determining the frequency characteristics of the MEMS microphone 100E may be a combined resistance of the acoustic resistance of the opening 70D and the acoustic resistance of the gap 74.

### Effects of MEMS Microphone 100E According to Fifth Embodiment

The MEMS microphone 100E according to the fifth embodiment as described above produces substantially the same effects as those produced by the MEMS microphone 100 according to the first embodiment as described above. The opening 70E for frequency characteristics adjustment may be disposed to face the first surface 10a of the substrate 10 in the Z-axis direction. This suppresses the entry of foreign matter into the opening 70E. Therefore, it is possible to suppress the entry of foreign matter into the space between the diaphragm 20E and the fixed electrode 40.

### Positional Relationship Between Opening 70 for Frequency Characteristics Adjustment and Opening 11 of Substrate 10

As illustrated in FIG. 3, the opening 70 for frequency characteristics adjustment may be disposed to overlap with the opening 11 of the substrate 10 as viewed in the Z-axis direction. According to the MEMS microphone 100 having this configuration, the acoustic resistance determining the frequency characteristics is determined only by the acoustic resistance of the opening 70 formed in the fixed film 22. Therefore, compared to the MEMS microphone 100E according to the fifth embodiment as described above, variation in the frequency characteristics (manufacturing variation) is small.

### Modified Example

According to the MEMS microphone 100 according to the modified example, the inner diameter of the hole 31 formed outward of the region R1 may be larger than the inner diameter of the hole 31 formed in the region R1. The inner diameter of the hole 31 disposed at a position overlapping with the opening 70 for frequency characteristics adjustment may be larger than the inner diameter of the hole 31 formed in the region R1 as viewed in the Z-axis direction.

The present disclosure can provide an acoustic transducer that can suppress the entry of foreign matter into the space between the diaphragm and the fixed electrode.

It should be noted that other embodiments may be made by combining other components with the configurations and the like described in the above embodiments, and the present disclosure is not limited to the configurations described herein in any way. The above embodiments can be changed without departing from the spirit of the present disclosure, and may be appropriately determined in accordance with the intended applications.

What is claimed is:

1. An acoustic transducer, comprising:
a substrate having an opening;
a diaphragm disposed to cover the opening; and
a fixed electrode facing the diaphragm, wherein
an opening for frequency characteristics adjustment is formed in a region outward of an outer periphery of the fixed electrode.

2. The acoustic transducer according to claim 1, wherein
the opening for frequency characteristics adjustment is provided in the diaphragm.

3. The acoustic transducer according to claim 1, wherein
a plurality of openings for frequency characteristics adjustment are provided, the plurality of openings each being the opening for frequency characteristics adjustment.

4. The acoustic transducer according to claim 2, wherein
the diaphragm includes
a movable film that is vibratable in a first direction that is a plate thickness direction of the substrate, and
a fixed film that is disposed around the movable film and is fixed to the substrate, and
the opening for frequency characteristics adjustment is provided in the movable film.

5. The acoustic transducer according to claim 4, wherein
the opening for frequency characteristics adjustment is provided at a position facing the opening of the substrate.

6. The acoustic transducer according to claim 2, wherein
the diaphragm includes
a movable film that is vibratable in a first direction that is a plate thickness direction of the substrate, and
a fixed film that is disposed around the movable film and is fixed to the substrate, and
the opening for frequency characteristics adjustment is provided in the fixed film.

7. The acoustic transducer according to claim 6, wherein
the opening for frequency characteristics adjustment is provided at a position facing the opening of the substrate.

8. The acoustic transducer according to claim 1, further comprising:
a support that is disposed between the substrate and the diaphragm, is disposed so as to enclose the opening of the substrate, and supports the diaphragm, wherein
the opening for frequency characteristics adjustment penetrates through the support.

9. The acoustic transducer according to claim 1, further comprising:
a back plate fixed to the substrate, wherein
the fixed electrode is formed at a surface of the back plate facing the diaphragm,
the back plate has a plurality of holes that penetrate through the back plate in a plate thickness direction, and
an area of the opening for frequency characteristics adjustment is smaller than that of the plurality of holes.
